(19) United States
(12) Patent Application Publication
(10) Pub. No.: US 2012/0062566 A1
(43) Pub. Date: Mar. 15, 2012

(54) Methods And Systems For Stylized Map Generation

(75) Inventor: Stefan KUHNE, San Jose, CA (US)

(73) Assignee: Google Inc., Mountain View, CA (US)

(21) Appl. No.: 13/023,886

(22) Filed: Feb. 9, 2011

Related U.S. Application Data
(60) Provisional application No. 61/381,232, filed on Sep. 9, 2010.

(51) Int. Cl. G06T 15/10; G06T 15/80

(52) U.S. Cl. 345/426; 345/419

(57) ABSTRACT

Systems, methods and articles of manufacture for stylized map generation are described herein. An embodiment includes enabling a user to provide a geographical region of interest, retrieving a multi-dimensional data set associated with the region of interest, determining an area outline of the region of interest based on an intersection of the data set with the region of interest, and generating a graphical representation of the region of interest and the area outline based on the data set. The embodiment further comprises instantiating a shader to generate the area outline and obtaining a shader algorithm to configure the shader. An embodiment includes applying a style package to the generated representation and modifying the style package using the shader algorithm. In this way, embodiments of the invention enable creation of stylized maps to visualize information associated with a geographical region.

### CROSS-REFERENCE TO RELATED APPLICATION

This patent application claims the benefit of U.S. Provisional Patent Application No. 61/381,232 (Attorney Docket No. 2525.2840000), filed Sep. 9, 2010, entitled “Methods and Systems For Stylized Map Generation,” which is incorporated herein by reference in its entirety.

### BACKGROUND

1. Field

Embodiments generally relate to digital map creation and visualizing data on digital maps.

2. Background

Users of digital mapping and three dimensional (3D) geographical modeling/viewing applications may create different maps to satisfy their requirements. Digital maps can include different map colors, sizes and fonts that enable users to interpret information being conveyed by such maps. In order to effectively convey information, digital maps as well as 3D geographical representations need to be adapted to user presentation needs. However, creation of custom map representations to visualize geographically linked information is a difficult and time consuming process.

### BRIEF SUMMARY

Embodiments of the present invention relate to stylized map generation. An embodiment includes enabling a user to provide a geographical region of interest, retrieving a multi-dimensional data set associated with the region of interest, determining an area outline of the region of interest based on an intersection of the data set with the region of interest, and generating a graphical representation of the region of interest and the area outline based on the data set. The embodiment further comprises instantiating a shader to generate the area outline and enabling the user to provide a shader algorithm to configure the shader. An embodiment includes applying a style package to the generated representation and modifying the style package using the shader algorithm.

In this way, embodiments of the invention enable creation of stylized maps to visualize information associated with a region of interest.

Further embodiments, features, and advantages of the embodiments, as well as the structure and operation of the various embodiments are described in detail below with reference to accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1A illustrates a system for stylized map generation, according to an embodiment.

FIG. 1B illustrates a system for stylized map generation, according to another embodiment.

FIG. 1C illustrates an exemplary user interface for enabling stylized map generation, according to an embodiment.

FIGS. 1D-1G illustrate exemplary user interfaces for enabling a user to provide simplified styling options, according to an embodiment.

FIGS. 2A-2H illustrate exemplary shaders and their respective outputs, according to an embodiment.

FIG. 2I illustrates a representation engine, according to an embodiment.

FIG. 3 is a flowchart illustrating an exemplary overall operation, according to an embodiment.

FIG. 4 is a flowchart illustrating modification of a style package, according to an embodiment.

FIG. 5 illustrates an example computer useful for implementing components of embodiments of the invention.

### DETAILED DESCRIPTION

Embodiments relate to stylized map generation. As discussed above, an embodiment includes enabling a user to provide a geographical region of interest, retrieving a multi-dimensional data set associated with the region of interest, determining an area outline of the region of interest based on an intersection of the data set with the region of interest, and generating a graphical representation of the region of interest and the area outline based on the data set. The embodiment further comprises instantiating a shader to generate the area outline and enabling the user to provide a shader algorithm to configure the shader. An embodiment includes applying a style package to the generated representation and modifying the style package using the shader algorithm.

In this way, embodiments of the invention enable creation of stylized maps to visualize information associated with a geographical region.

While the present embodiments are described herein with reference to illustrative applications, it should be understood that the embodiments are not limited thereto. Those skilled in the art with access to the teachings provided herein will recognize additional modifications, applications, and embodiments within the scope thereof and additional fields in which the embodiments would be of significant utility.

### Table of Contents

1. System
2. Shader Algorithms and Style Packages
3. Border Outline Creation
   3.1 Enabling Creation of A Single Border Outline
   3.2. Enabling Creation of Multiple Border Outlines
   3.3. Enabling Creation of Multiple Border Outlines With Simple Data Styling
   3.4. Enabling Creation of Multiple Border Outlines With Full Data Styling
4. Data Table and Data Set Entry Format
5. Example Computer Embodiment

### 1. System

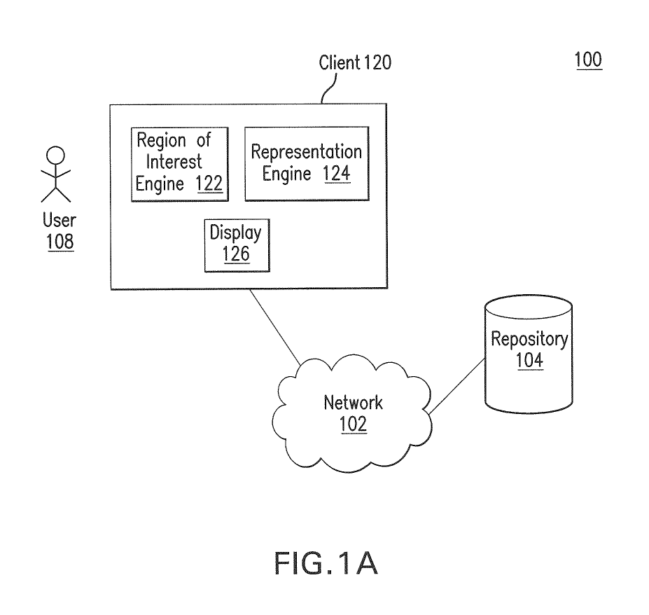

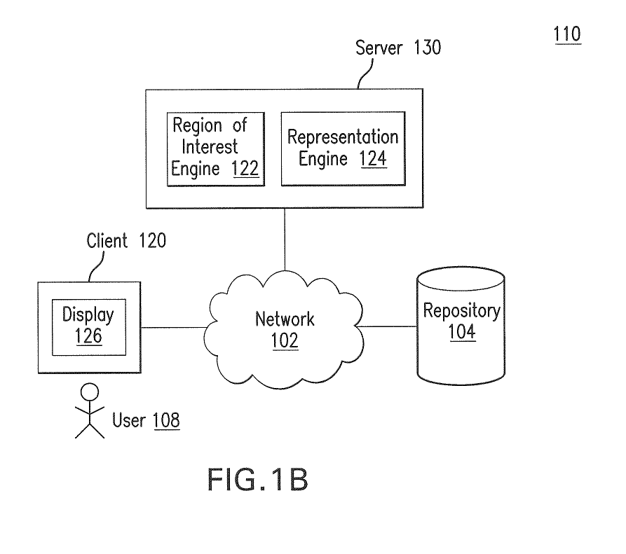

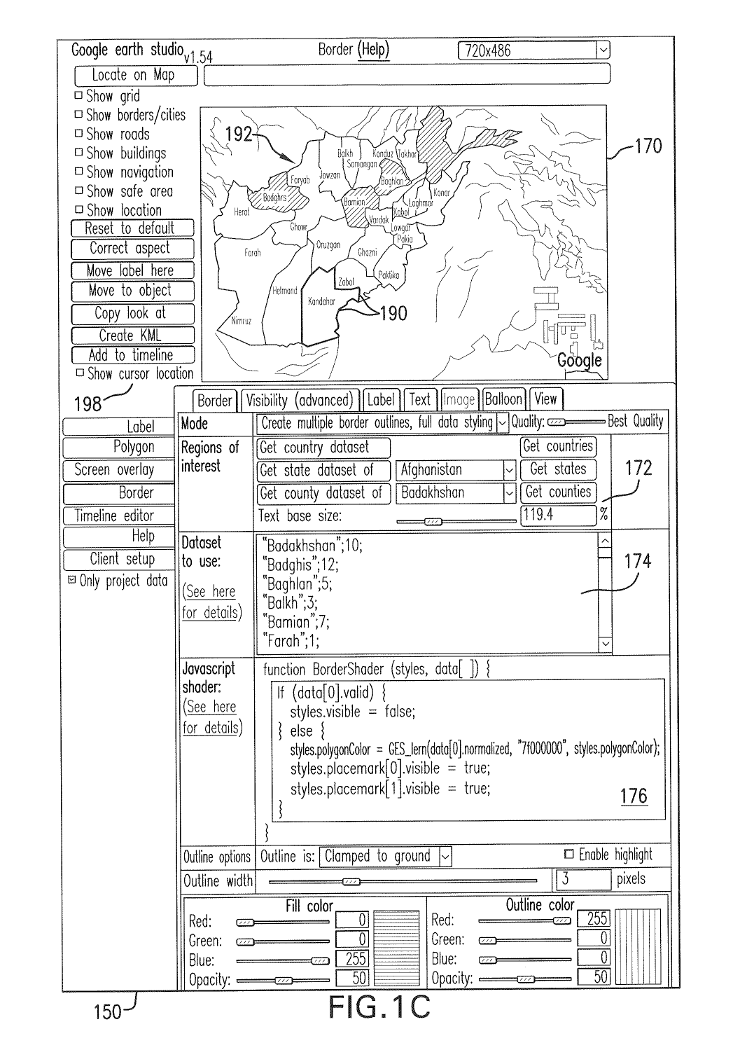

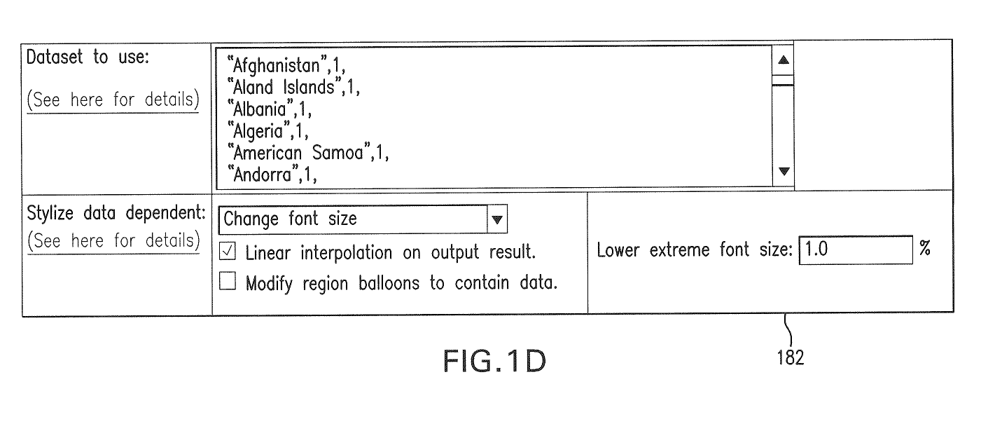

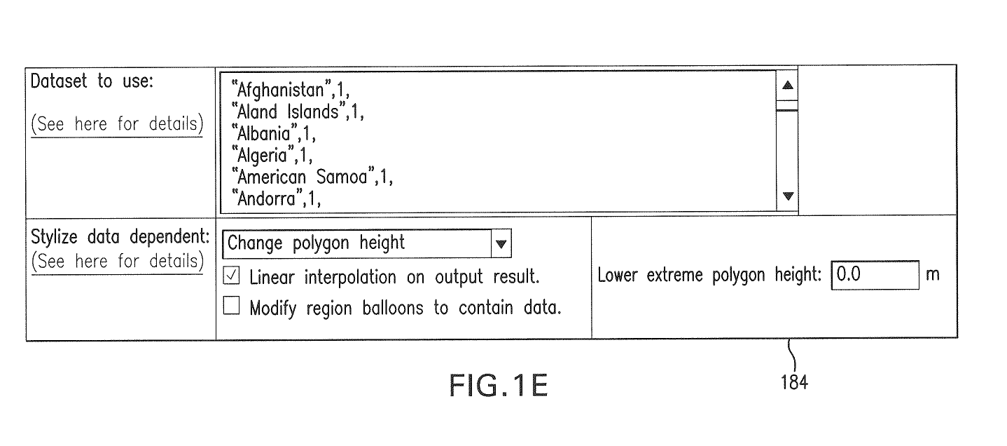

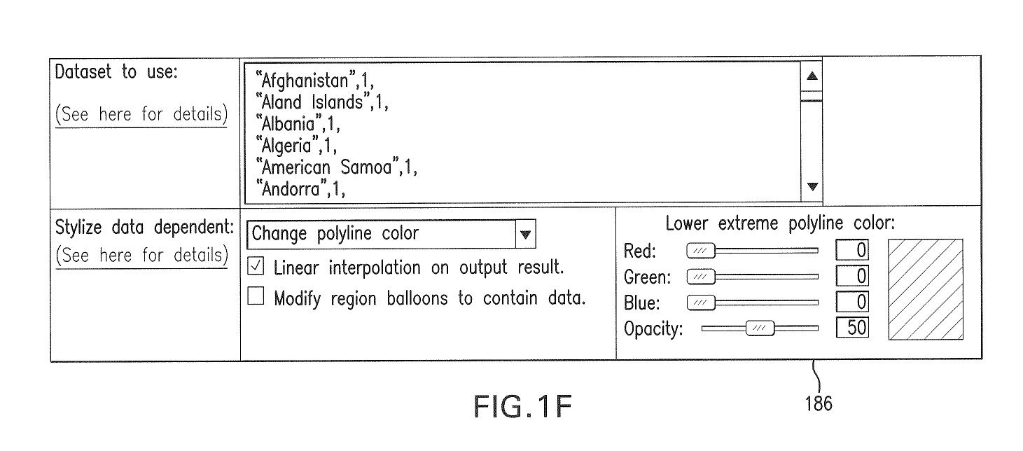

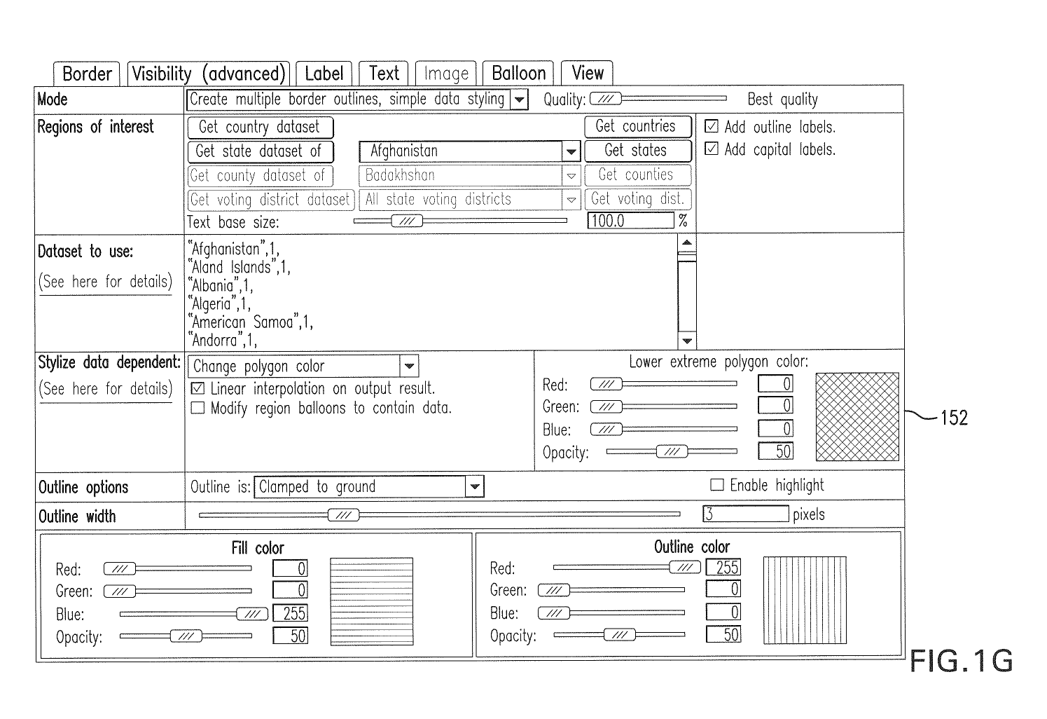

This section describes a system for stylized map generation according to an embodiment illustrated in FIG. 1A. FIG. 1A is a diagram of a system 100 for stylized map generation, according to an embodiment. While the following is described in terms of geographical and terrestrial data, the embodiments are not limited to such data and the techniques described herein and can be applied to any other form of data, including, but not limited to, oceanic data, astronomical data, extraterrestrial data, or any combination thereof. The embodiments are applicable to any system having generally the structure of FIG. 1A, or that would benefit from the operation, methods and functions as described herein.

System 100 includes client 120 and repository 104 connected over network 102. In the embodiment illustrated in FIG. 1A, client 120 includes region of interest engine 122, representation engine 124 and display 126. User 108 can interact with client 120 to provide data to client 120 and receive (or view) data from client 120.

In an embodiment, repository 104 can be configured to store a plurality of data sets. The data sets may include both single and multi-dimensional data sets. Multi-dimensional data sets can include a plurality of statistics and data associated with a region of interest. As a non-limiting example, repository 104 can include data related to human populations, which may be categorized by regions, or even election results from a plurality of regions. The data sets may also include road maps of geographical regions. Repository 104 may also include any other form of data that is associated with one or more terrestrial, oceanic or astronomical regions.

Network 102 may include one or more networks, including but not limited to, a local area network, medium-area network, and/or wide-area network, such as the Internet. Network 102, for example, may be any form of wired or wireless network that allows client 120, repository 104, and any additional clients or servers to communicate with each other.

Client 120 can be any type of processing (or computing) device having one or more processors. For example, client 120 can be a workstation, mobile device (such as a mobile phone tablet or laptop), computer, cluster of computers, set-top box, embedded system, console, or other device having at least one processor. Such a processing device may include software, firmware, hardware, or a combination thereof. Software may include one or more applications and an operating system. Hardware can include, but is not limited to, a processor, memory and graphical user interface display. User 108 can interact with client 120 to provide data to client 120 and receive (or view) data from client 120. As shown in. FIG. 1A, client 120 includes region of interest engine 122 and representation engine 124.

In an embodiment, region of interest engine 122 is configured to obtain a region of interest and to determine an area outline of the region of interest. As an example, user 108 can provide a region of interest (e.g., country or state) to region of interest engine 122 using client 120. In an embodiment, an area outline that is determined by region of interest engine 122 can be based on an intersection of a data set in repository 104 with the region of interest provided by user 108. For example, if the region of interest is ‘County A’, an intersection of this region of interest with a data set in repository 104 will return all data from the data set that is associated with County A. Representation engine 124 is configured to generate a graphical representation of the region of interest and the area outline based on the data set. In an embodiment, the representation engine 124 renders the graphical representation for display on display 126. In an embodiment, the graphical representation comprises a shaded (e.g., color shaded) region and place-mark map. A place-mark, for example, can identify one or more points or regions of interest on a digital map. In one example, representation engine 124 may operate automatically, without user intervention, to generate a graphical representation. The operation of region of interest engine 122 and representation engine 124 is described further below.

FIG. 1B is a diagram of system 110 for stylized map generation, according to another embodiment. System 110 includes server 130, client 120 and repository 104. In system 110, region of interest engine 122 and representation engine 124 are implemented on server 130. Server 130, client 120 and repository 104 communicate with each other via network 102. In system 110, data is provided from client 120 to region of interest engine 122 and representation engine 124 via network 102. In this way, region of interest engine 122 and representation engine 124 operate outside client 120. Although FIG. 1B illustrates a single client for clarity, it is to be appreciated that the system 110 (and even system 100) is scalable and can work with a plurality of clients 120. In an embodiment, the configuration of system 110 enables a plurality of processing operations to be transferred to server 130 independent of client 120. Such configuration may also enable region of interest engine 122 and representation engine 124 to pre-process data stored in repository 104 before it is requested by client 120. It is to be appreciated that that embodiments may operate without network 102 and that repository 104 may reside locally on client 120 in both system 100 and system 110.

FIG. 1C illustrates an exemplary user interface 150 for enabling stylized map generation, according to an embodiment. User interface 150 enables user 108 to efficiently create stylized maps using region of interest engine 122 and representation engine 124 to visualize geographically-related information. Such stylized map visualizations include region outlines, place-marks and polygons which are dynamically adaptable to user 108′s presentation needs (e.g., illustrating real-time election results). Map visualizations can also include custom colors, sizes, and fonts as well as custom images, custom font line spacing, custom font shadowing, custom font/shadow smoothing, custom font outlining and other means and forms or graphical visualization and artistic styles Stylized maps may be generated and displayed within user interface 150 by region of interest engine 122 and representation engine 124. As an example, not intended to limit the invention, user interface 150 may be a user interface of the GOOGLE EARTH STUDIO application available from Google Inc. of Mountain View, Calif.

User interface 150 enables user 108 to interact with region of interest engine 122 and representation engine 124 via client 120. As an example, user 108 may view user interface 150 on display 126 and may interact with user interface 150 using a mouse, digital pen or even by using a touch screen implemented on display 126. These examples are not limiting and in general any graphical user input, voice input or any other user input can be used in user interface 150.

User interface 150 includes representation 170, region of interest selection area 172, data set entry area 174 and shader entry area 176. In an embodiment, representation 170 is a stylized map generated by region of interest engine 122 and representation engine 124. Representation 170 further includes regions 192 and outlines 190. In an embodiment, representation 170 can be manipulated by using visualization control 198. As an example, representation 170 can be any digital map, 3D topography representation, satellite imagery or any combination thereof. Region of interest selection area 172 enables user 108 to define regions of interest (e.g., regions 192) and data set entry area 174 enables user 108 to define one or more data sets of interest from repository 104. It is to be appreciated that user 108 can select, add or edit data any user interface element in user interface 150. Such user interface elements can include, but are not limited to, menus, sliders, text entry areas, buttons, etc. As an example, data set entry area 174 and shader entry area 176 can be text input areas.

User interface 150 enables user 108 to define a data set that includes an area of interest together with an n-dimensional value tuple from a multi-dimensional data set in repository 104. The n-dimensional value tuple can include data associated with one or more regions of interest (e.g., election results from different regions). The defined data set is intersected with a region of interest (e.g., all counties in a state) by region of interest engine 122 to determine relevant region outlines based on the defined data set. This defined data set may be stored in repository 104 and can be retrieved by shader 210 to further stylize determined area outlines. The defined dataset can also include strings that can overwrite default text appearing in representation 170. The operation of shader 210 is discussed below.

### 2. Shader Algorithms and Style Packages

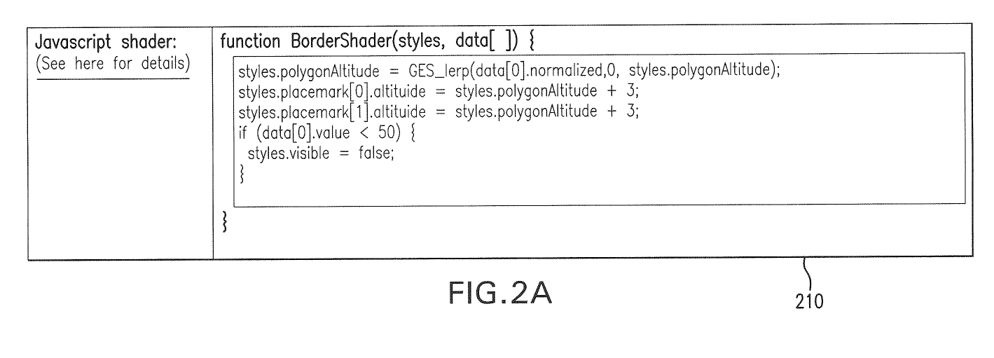

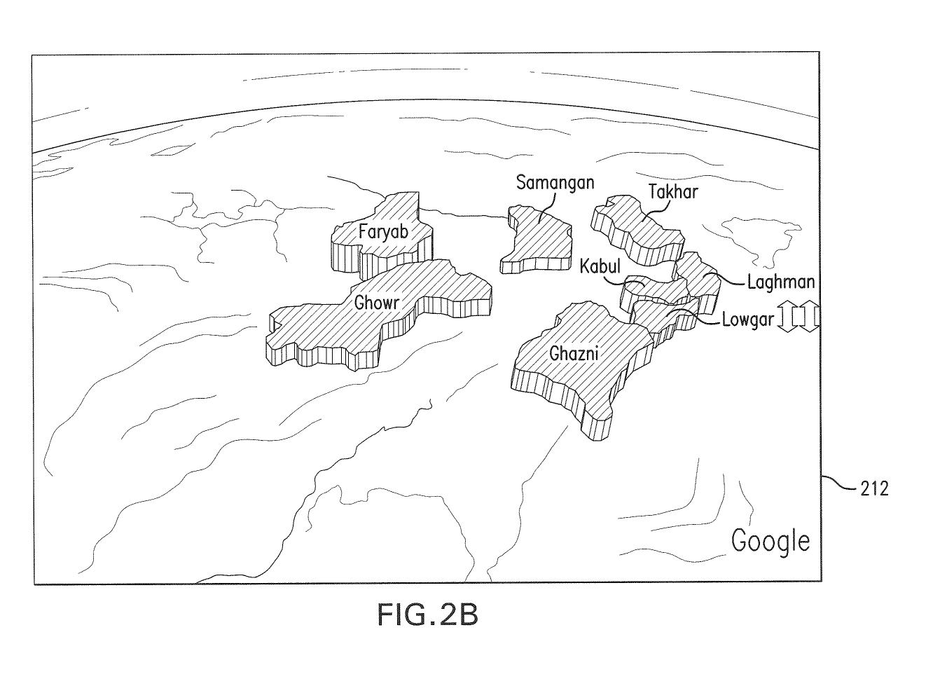

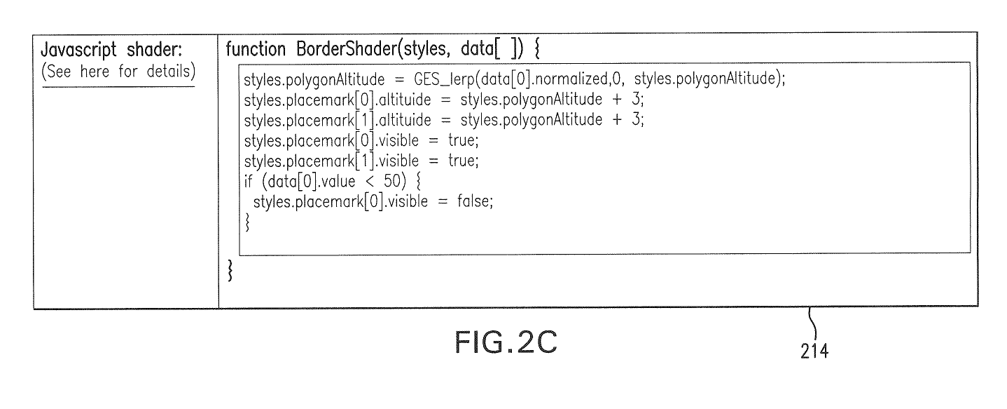

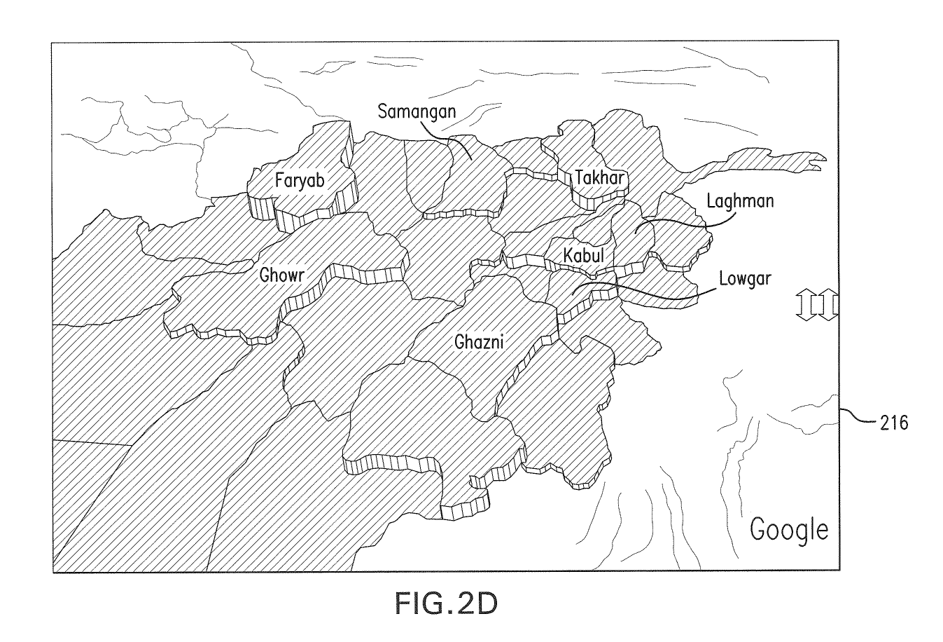

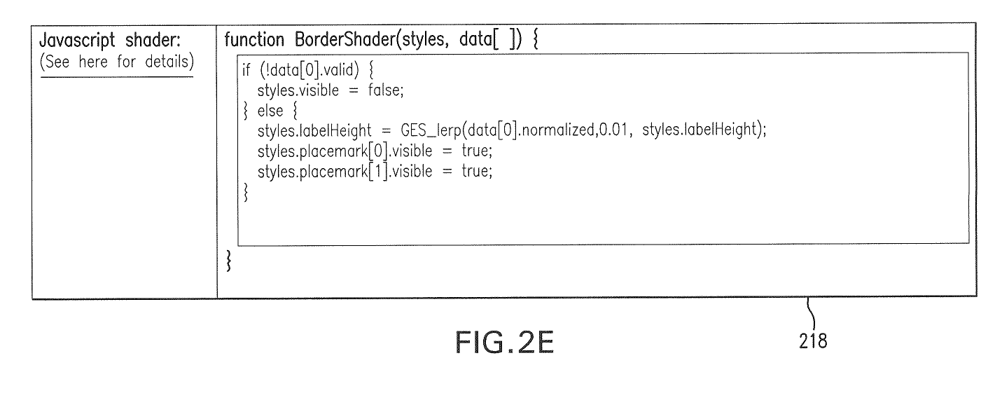

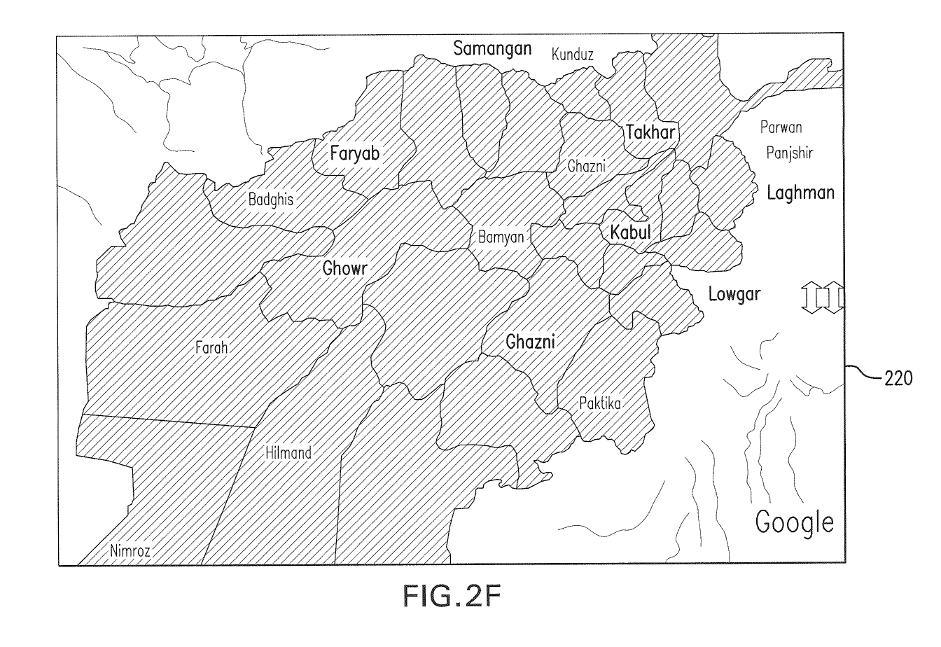

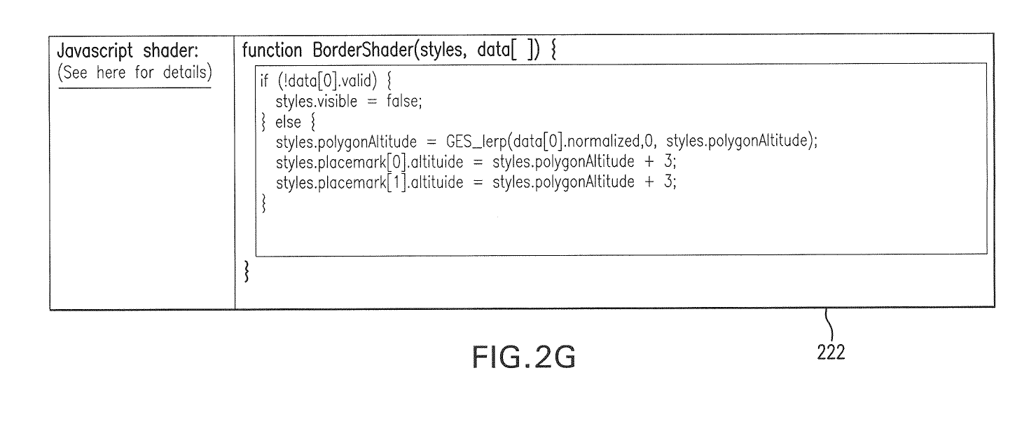

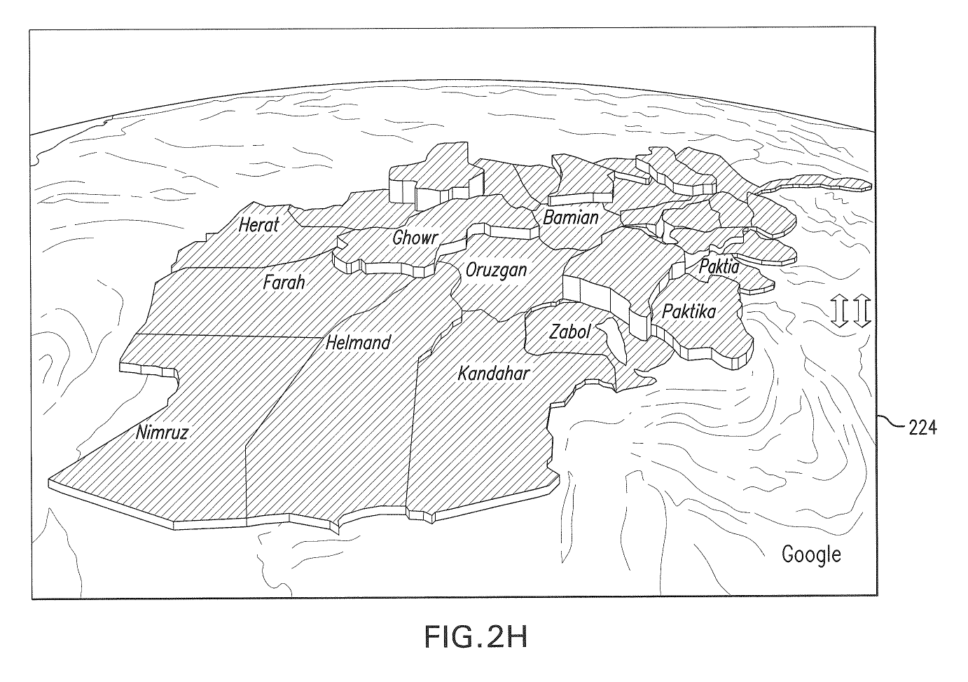

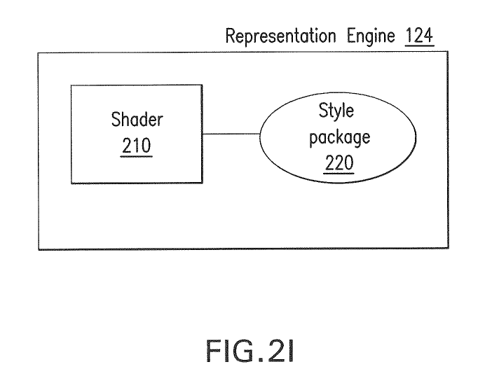

FIG. 2I illustrates a diagram of representation engine 124 in greater detail, according to an embodiment. In an embodiment, representation engine 124 generates a stylized map (e.g., representation 170 illustrated in user interface 150). As shown in FIG. 2I, representation engine 124 includes shader 210 and style package 220. In an embodiment, shader 210 generates a stylized area outlines (e.g., outlines 190) using representative values from each dimension of a multi-dimensional data set in repository 104. As discussed above, data set entry area 174 enables users to select one or more data sets of interest from repository 104.

Shader entry area 176 enables user 108 to define a shader algorithm to configure shader 210. As an example, user 108 can configure shader 210 to change a pre-defined visual base representation. A pre-defined visual base representation may be dependent on data associated with a region of interest.

In an embodiment, a shader algorithm is code processed by shader 210 that enables representation engine 124 and region of interest engine 122 to stylize border outline attributes (e.g., outlines 190) based on data sets in repository 104.

In a non-limiting embodiment, shader 210 retrieves data set elements from repository 104 to stylize representation 170. In an embodiment, shader 210 retrieves elements of a user defined multi-dimensional data set stored in repository 104 to stylize representation 170. As discussed above, the multi-dimensional data set may include an area of interest together with an n-dimensional value tuple. As an example, this multi-dimensional data set includes data associated with a region outline from all data set(s) together with a default style. Shader 210 outputs a modified style using the multi-dimensional data set. In an embodiment, shader 210 outputs a modified style using each dimension of the multi-dimensional data set. Representation engine 124 may use the modified style to generate, for example, stylized region outlines in representation 170.

In an embodiment, shader 210 generates a modified style by using a shader algorithm to perform a computation based on minimas and maximas of the multi-dimensional data set. In an embodiment, values other than the maximas and the minimas of the multi-dimensional data set need not be accessed by shader 210. Alternatively, shader 210 can use a pre-defined interpolation function to generate a modified style. Exemplary interpolation methods, include, but are not limited to, linear interpolation, quantization and mapping functions.

### Linear Interpolation

In an embodiment, a linear interpolation blends two representative values in a data set using a ‘normalized’ value (e.g., a number between 0.0 and 1.0). For example, a linear interpolation function to compute a polygon altitude that is dependent on data defined by user 108 is as follows:

styles.polygonAltitude=GES_lerp(data[0].normalized, 1000, 1000000);

As an example, a polygon altitude represents an altitude of a polygon resulting from an extrusion of one or more regions of interest in representation 170.

The example linear interpolation function shown above would create polygon altitudes between 1000 and 1000000 units that are dependent on a normalized number from a data set.

In an embodiment, a linear interpolation function can also interpolate colors as follows:

styles.polygonColor=GES_lerp(data[0].normalized, “7f000000”, styles.polygonColor);

This exemplary color interpolation blends a pre-defined user interface color and a semi-transparent black color.

### Mapping

In some cases, linear interpolation may result in a few ‘clustered’ values/colors in representation 170 and user 108 may not be able to distinguish between adjacent or nearby values/colors. To address such cases, representation engine 124 maps data values provided by user 108 to n buckets and may assign a bucket number to address each individual bucket.

For example, if user 108 provides a data set of {1, 2, 3, 3, 90, 99, 100}, but would like to illustrate only four distinguishable color tones (in representation 170) to represent the seven values appearing in the data set, user 108 may need to group the seven values into four groups (e.g., (1,2), (3,3), (90), (99, 100)). Each group can then be assigned a unique color tone. To efficiently accomplish illustration of distinguishable color tones mapped to a plurality of values (i.e., 1, 2, 3, 3, 90, 99, 100), user 108 can provide the following exemplary shader algorithm to shader 210 using shader entry area 176:

var color_map=[‘ffffffff’, ‘ffff0000’, ‘ff0000ff’, ‘ff000000’];

styles.polygonColor=color_map[GES_Map(0, 4)];

Based on the above shader algorithm, shader 210 is configured to show four distinguishable colors that map to the range of values provided by user 108. It is to be appreciated that embodiments of the invention can map any number of data set values to any number of user interface colors and the embodiments are not-limited to the example values discussed herein.

### Quantization

Quantization can also generate distinguishable features or color values using data set elements. In an embodiment, quantification performed by representation engine 124 generates distinguishable colors based on the number of unique values in a data set.

For example, a data set of {1, 2, 3, 3, 5, 5, 5, 90, 100} has six distinguishable values, i.e., 1, 2, 3, 5, 90 and 100. Thus, an exemplary function to generate distinguishable colors would assign data set value 1 a first color value, and assign data set value 2 a value that is ⅙^{th} of the value assigned to element 1. Other data set elements would be assigned values in a similar manner.

An example of a shader algorithm that includes a quantification function is as follows:

styles.polygonColor=GES_Quantify(0, “7f000000”, styles.polygonColor);

One non-limiting way to configure shader 210 includes enabling selection of a shader mode and a visualization scheme of interest by user 108, and then enabling user 108 to switch to a shader editing mode. A pre-defined shader algorithm is then shown in shader entry area 176 and can be modified by user 108.

In an embodiment, shader 210 can create shader algorithms or stylize representation 170 independent of data provided in shader entry area 176. In an embodiment, a shader algorithm can get inspected for malicious code by shader 210 before the shader algorithm is used for processing data. In an embodiment, a shader algorithm can be interpreted by shader 210 in real time (i.e., “on-the-fly”) as the algorithm is being provided by user 108 into shader entry area 176.

Example 1 illustrates an exemplary format of a shader algorithm that can be provided to shader 210 using shader entry area 176.

```
    /**
    *  This example  shader  algorithm  changes  the style  according
to  multiple  parameter value pairs.
  * @param {StyleStructure} styles The style of the object.
  * @param {Array.<ParameterStructure>} data An array of parameters.
  */
  function(styles, data) {
    // StyleStructure can be read and modified according to parameters.
  }
```

### EXAMPLE 1

Example 2, shown below, is a shader algorithm that can be used to configure shader 210 to show and hide place-marks in representation 170. In Example 2, place-marks are shown and hidden based on maximum and minimum values in a data set.

```
if (data[0].value < data[0].min + (data[0].max − data[0].min * 0.10)
{
  style.visible = false;
  return;
}
```

### EXAMPLE 2

Example 3, shown below, is a shader algorithm that can be used to configure shader 210 to modify height of a label in representation 170. As an example, such modification can be achieved by multiplying a requested height with a normalized value based on one or more values in a data set.

style.borderLabelHeight=style.borderLabelHeight*data

### EXAMPLE 3

Example 4, shown below, is a shader algorithm that can be used to configure shader 210 to modify values that are displayed in balloons (or pop-ups) when user 108 selects regions of interest 192 in representation 170. In this way, balloons can be used to display relevant information associated with a region of interest in representation 170.

```
    // The outline name in bold.
    styles.balloon = “<b>” + styles.name + “</b>”;
    if (data[0].valid) {
      // Open a table.
      styles.balloon += “<br /><br /><table>”;
      // Add the population value for this area (which is the first value
      of the data set).
      styles.balloon += “<tr><td><b>Population:</b></td><td>” +
data[0].value + “</td><tr>”;
      if (data[1].valid) {
      // Add the healthcare expense (which is the second value of
      the data set).
      styles.balloon += “<tr><td><b>Overall healthcare
expenses:</b></td><td>” + data[1].value + “</td><tr>”;
      if (data[0].value) {
        // The median healthcare expense is the number of people
divided by the amount spent.
        styles.balloon += “<tr><td><b>Median healthcare per
person:</b></td><td>” + (data[1].value/data[0].value) + “</td><tr>”;
      }
      if (data[2].valid) {
        // The third number of the data set is the number of children
        per household.
        styles.balloon += “<tr><td><b>Children per
household:</b></td><td>” + data[2].value + “</td><tr>”;
      }
      }
      // Close the table.
      styles.balloon += “</table>”;
    }
```

### EXAMPLE 4

In an embodiment, user 108 can also configure shader 210 to include data in an outline name. For example, such data may be embedded and displayed in outline 190. Such operation can be achieved by configuring shader 210 using the shader algorithm shown in Example 5 below.

```
    if (data[0].valid) {
      // Select a name and append a first statistics value.
      styles.placemark[0].displayName =
styles.placemark[0].dataName + ‘\n’ + data[0].value +
‘ voters’;
      // Increase textbox height to a factor of two.
      styles.labelHeight = 2.0;
    } else {
      // Select a name.
      styles.placemark[0].displayName = styles.placemark[0].dataName;
      // Decrease textbox height to 1.
      styles.labelHeight = 1.0;
    }
```

### EXAMPLE 5

It is to be appreciated that Examples 1-5 shown above are purely illustrative and are not intended to limit the invention.

In an embodiment, representation engine 124 can instantiate (or call) shader 210 for each area outline (e.g., outlines 190) in representation 170 and provides shader 210 with data that includes a data value for each dimension from a data set in repository 104. Representation engine 124 can also provide shader 210 with the data set's minimum, median and maximum values. Such data enables shader 210 to generate a visual representation that can be dependent on the data. In addition, representation engine 124 also provides shader 210 with style package 220 which can be applied to regions of interest 192. In an embodiment, style package 220 can be modified by shader 210 using a shader algorithm.

In an embodiment, style package 220 can define (or specify):

(a) Visibility of an area, place-marks and fill color. In addition, style package 220 can also define polygon color, line color, line width, polygon altitude, polygon extrusion, etc.

(b) Place-mark properties that include string and text attributes (e.g., font, color, shadow, etc.)

(c) Balloon information (or ‘pop-ups’) to display and enable creation of dynamic content associated with regions of interest 192.

(d) Highlight and styles (e.g., Regions that can be highlighted and visualization styles that may be updated based on mouse or touch events.)

In an embodiment, visualization styling of representation 170 occurs in real time and can be based on user interaction with representation 170. Furthermore, visualization styling accomplished by representation engine 124 may update in real-time based on changes to data stored in repository 104.

FIG. 2A illustrates an exemplary conditional shader 210, according to an embodiment. FIG. 2B illustrates an exemplary output 212 associated with the conditional shader of FIG. 2A, according to an embodiment. As illustrated in FIG. 2B, different regions of interest have been extruded as polygons by the shader of FIG. 2A. FIG. 2C illustrates an exemplary conditional placemark change shader 214, according to an embodiment. FIG. 2D illustrates an exemplary output 216 associated with the conditional placemark shader 214 of FIG. 2C. As illustrated in FIG. 2D, different regions of interest have their placemarks (e.g., name labels) visible or hidden by the shader 214 of FIG. 2C. FIG. 2E illustrates an exemplary font size shader 218, according to an embodiment. FIG. 2F illustrates an exemplary output 220 associated with the font size shader of FIG. 2E. As illustrated in FIG. 2F, different regions of interest have different label font sizes generated by the shader of FIG. 2E. FIG. 2G illustrates an exemplary polygon height shader 222, according to an embodiment. FIG. 2H illustrates an exemplary output 224 associated with the polygon height shader of FIG. 2G. As illustrated in FIG. 2H, different regions of interest have different extruded polygon heights generated by the shader of FIG. 2G.

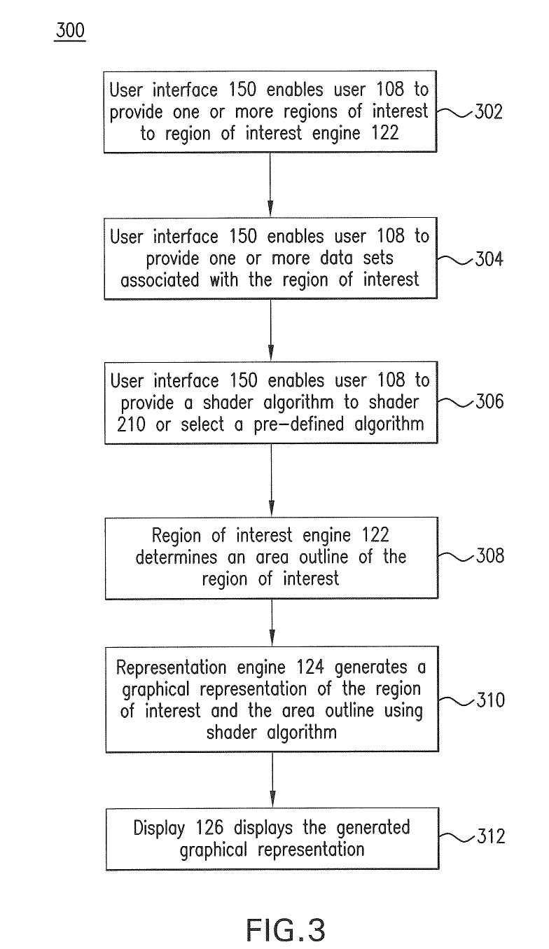

FIG. 3 is a flowchart illustrating an exemplary overall operation of system 100, according to an embodiment.

Method 300 begins when user interface 150 enables user 108 to provide one or more regions of interest to region of interest engine 122. Referring to user interface 150, region of interest selection area 172 enables user 108 to provide one or more regions of interest (e.g., regions 192) to region of interest engine 122. In another example, region of interest engine 122 may automatically select any pre-defined region of interest that may be stored in repository 104. In yet another example, user 108 may select regions of interest by using a mouse, light pen or event a touch input on representation 170.

User interface 150 enables user 108 to select one or more multi-dimensional data sets associated with the region of interest (step 304). As an example, data set entry area 174 in user interface 150 enables user 108 to select one or more data sets from repository 104. In another example, region of interest engine 122 may also automatically use any pre-defined multi-dimensional data set that may be stored in repository 104.

User interface 150 enables user 108 to provide a shader algorithm for shader 210 (step 306). As an example, user interface 150 enables user 108 to provide a shader algorithm using shader entry area 176. In another example, shader 210 can automatically use a pre-defined shader algorithm that may be stored in shader 210 or repository 104. In yet another example, user 108 may select a pre-defined method of mapping visualization parameters (e.g., outline color, polygon height etc.) to a dataset associated with a region of interest. For example, user 108 may user the exemplary user interfaces 182, 184 and 186 illustrated in FIGS. 1D, 1E and 1F to change font size, polygon height and a polygon outline color respectively in representation 170.

Region of interest engine 122 determines an area outline of the one or more regions of interest provided by user 108 (step 308). In an embodiment, such an area outline can be based on an intersection of a data set in repository 104 with the one or more regions of interest provided by user 108. As an example, region of interest engine 122 determines outlines 190 of regions 192 in representation 170.

Representation engine 124 generates a graphical representation of the region of interest and the area outline using a shader algorithm (step 310). As an example, representation engine 122 generates stylized representation 170 that includes outlines 190 of regions 192.

Display 126 displays the generated graphical representation (step 312). As an example, display 126 displays representation 170 in user interface 150.

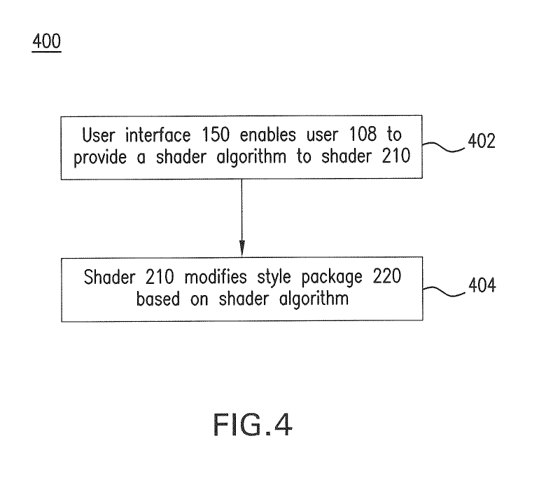

FIG. 4 is a flowchart illustrating modification of a style package, according to an embodiment.

Method 400 begins with user interface 150 enabling user 108 to provide a shader algorithm to shader 210 (step 402). As an example, user interface 150 enables user 108 to provide a shader algorithm using shader entry area 176. In another example, shader 210 can use a pre-defined shader algorithm that may be stored in shader 210 or repository 104.

Shader 210 then modifies style package 220 using the shader algorithm (step 404). As discussed above, style package 220 may define, for example, visibility of an area, place-marks, fill color, and several other attributes of representation 170. Representation engine 124 can then update representation 170 to reflect any desired visualization style based on modified style package 220.

As will be described in the following sections, embodiments of the invention offer multiple modes that enable user 108 to obtain a visualization style adapted to a level of sophistication.

### 3. Border Outline Creation

In an embodiment, representation engine 124 offers different border creation modes through user interface 150 which are discussed below.

### 3.1 Enabling Creation of a Single Border Outline

In this exemplary mode, user interface 150 and representation engine 124 enable user 108 to create a single border outline at a time. For example, user interface 150 can enable selection of country, province, or county of interest. Furthermore, user interface 150 also enables user 108 to type in a desired regional ZIP code and retrieves (from repository 104) a region of interest associated with the typed ZIP code.

Once a region of interest is obtained, representation engine 124 generates a region outline (e.g., outlines 190 of regions 192). User interface 150 displays the outline together with a textual name of the region of interest that is bound by the outline. Additional information, such as the name of a capital city of the region of interest, may be displayed as well within the region of interest.

In an embodiment, user interface 150 and representation engine 124 enable user 108 to stylize a region outline (e.g., outlines 192) using the following tools provided through user interface 150:

(a) Border Tool—In an embodiment, a border tool enables user 108 to modify or stylize the visualization of a polygon that may define the perimeter of a region of interest.

(b) Label, Text and Image Tool—In an embodiment, a label, text and image tool enables user 108 to modify place-mark(s) that may occur in a region of interest.

(c) Visibility and View Tool—In an embodiment, a visibility and view tool enables user 108 to modify the general appearance of user interface elements in user interface 150.

In an embodiment, user interface 150 also enables creation of style templates using representation engine 124. In a non-limiting embodiment, style templates may be stored in style package 220. In an embodiment, once an outline has been generated by representation engine 124, the outline can be saved as a style template for faster styling of other outlines in the future. To support such operation, user interface 150 enables user 108 to save style templates as a “border style.” User 108 may be able to set any border style as a default style. Once a style template has been created, representation engine 124 can stylize an object or item of interest when user 108 selects a saved style of interest. Furthermore, representation engine 124 can stylize an entire region border using the “border style” or even one item of interest (e.g., place-mark) using a saved “label style.”

Embodiments of the invention also enable user 108 to specify one or more visualization parameters to representation engine 124. These exemplary parameters include, but are not limited to:

(1) Quality: In an embodiment, user interface 150 enables user 108 to provide a quality parameter that defines data set complexity. As an example, in some scenarios, user 108 may need to illustrate multiple stylized outlines in representation 170. When many stylized outlines are to be illustrated in representation 170, system 100 or 110 may require greater processing resources and potentially require more time to render and display stylized outlines. By using the quality parameter, representation 170 may be stylized by representation engine 124 based on, for example, a subset of data in a data set. In this way, the quality parameter enables modification of data set complexity to obtain a less complex representation for faster rendering and display. In an embodiment, representation engine 124 matches the quality parameter used for all outlines in representation 170 so that they appear visually similar to each other when user 108 zooms in or zooms out of representation 170.

(2) Invert Area: In an embodiment, user interface 150 enables user 108 to provide an ‘invert area’ parameter. When the invert area parameter is enabled or set, representation engine 124 ‘fades out’ or obscures all displayed regions excluding region(s) of interest (e.g., regions 192) in representation 170. In this way, user 108 is more clearly able to visualize one or more regions of interest.

(3) Extrude: In an embodiment, user interface 150 enables user 108 to provide an ‘extrude from ground’ parameter. When this parameter is set or enabled, one or more regions of interest extrude as polygons from a level that is common to all regions on a map (e.g., ground level) to a pre-defined higher level in representation 170. This gives the region of interest a 3D appearance. In this way, a user is more clearly able to visualize one or more regions of interest.

(4) Visibility: In an embodiment, user interface 150 enables user 108 to provide a visibility parameter. Such a visibility parameter can be applied to an object or a group of objects in representation 170, allowing the objects to fade in or fade out of representation 170 at the same time. In an embodiment, visibility of one or more objects may be relative to a rendered size of an object on display 126. As a purely illustrative example, if an object occupies more then ‘x’ % (e.g., 20%) of area on display 126, the object can be configured to fade and if the same object occupies % (e.g., 10%) of area on display 126, the object can be hidden (or vice-versa). This example is purely illustrative and is not intended to limit the invention.

(5) Label: In an embodiment, user interface 150 enables user 108 to provide a label parameter that can be associated with a region of interest. User 108 can then select a label associated with a region of interest and may also modify the label.

In an embodiment, once a stylized map outline (e.g., outline 190) has been created by representation engine 124, user interface 150 can enable user 108 to add the outline to a timeline of generated outlines using an ‘Add To Timeline’ option in user interface 150. The outline can also be saved by client 120 in repository 104 for subsequent use by using a “Manage Borders” or “Save New” option. In addition, representation engine 124 can also create a KML file representing an outline of a region of interest. KML is a file format used to display geographic data. Such a KML file can be opened in a 3D terrain viewing application (e.g., GOOGLE EARTH from Google Inc. of Mountain View, Calif.). The KML file can also be saved by client 120 in repository 104 or even within client 120 itself.

### 3.2. Enabling Creation of Multiple Border Outlines

In this mode, user interface 150 and representation engine 124 enable user 108 to create and stylize multiple border outlines at a time. For example, user 108 can select an area of interest (that may include multiple regions of interest), and representation engine 124 can stylize the selected area as discussed above. Representation engine 124 can then retrieve and display a plurality of stylized regions of interest (e.g., by selecting a “Get Countries”/“Get States” or “Get Counties” option) in user interface 150.

In this mode, user interface 150 enables user 108 to modify and stylize a plurality of region outlines and other elements, together and at once, so that they have a consistent representation. For example, user interface 150 can enable modification of polygon attributes (e.g., altitude, altitude mode, extrusion, color, etc.) and a text base size in representation 170. Representation engine 124 can also set a single base text size for all place-marks. Furthermore, user interface 150 enables parallel modification of all text sizes in a plurality of regions to make the text sizes larger or smaller simultaneously. User interface 150 also enables modification of text labels in representation 170. For example, user 108 may modify location and size parameters that control appearance of labels in representation 170.

The following is an illustrative example of a scenario where multiple border outlines are created using user interface 150.

Initially, user 108 may have used the single border outline mode to create one outline in the style user 108 wants to use for each outline in representation 170. The user then changes mode to “Create Multiple Border Outlines.” User 108 then selects a region of interest (e.g., “Afghanistan”) and then clicks on the “Get States” option in user interface 150 resulting in a display of all states in Afghanistan and their respective border outlines in representation 170. The displayed state outlines can be of the style initially selected by user 108 in the single border outline mode.

The following is an illustrative example of creating multiple border outlines using simple data styling. In this mode, user 108 can select a subset of an area of interest in representation 170 and representation engine 124 styles each item in the subset individually by using a data set in repository 104.

3.3. Enabling Creation of Multiple Border Outlines with Simple Data Styling

In this example of creating multiple border outlines using simple data styling, user 108 may have previously used the single border outline mode to create an outline in a visualization style user 108 prefers to use for each outline. User 108 may also select a polygon color (e.g., select a solid blue color). User 108 then selects the “Create Multiple Border Outlines, Simple Data Styling” mode. Subsequently user 108 selects a region of interest (e.g., “Afghanistan”) and clicks on a “Get State Data Set Of' button in user interface 150 to populate the “Data Set to Use” text area in user interface 150.

User 108 then selects the “Get States” button to retrieve all outlines from region of interest engine 122. Outlines of regions of interest (e.g., states in Afghanistan) are now displayed in representation 170 in user interface 150. User 108 can now modify the displayed outlines in representation 170.

As discussed above, representation engine 124 dynamically stylizes representation 170 based on updates to data sets used to generate representation 170. When user 108, for example, changes data associated with regions of interest by using data set entry area 174, representation engine 124 re-styles the displayed outlines as user 108 changes the data.

For example, when user 108 changes values (e.g., 1, 2, 3, etc.) associated with each of the regions listed below, the outlines in representation 170 are re-styled by representation engine 124 as user 108 modifies the data through data set entry area 174.
“Badakhshan”;1;
“Badghis”;2;
“Baghlan”;3;
“Balkh”;4;
“Bamian”;5;

User 108 can also override some of the region names displayed in representation 170 by using data set entry area 174.

User 108 can add useful balloon (or pop-up) context information by checking the “Modify Region Balloons to Contain Data” selection in user interface 150. In this case, context information can be added by representation engine 124 to a text balloon.

User interface 150 also enables user 108 to highlight any regions or items within representation 170 using, for example, a mouse or a touch screen. In order enable such operation, user 108 can select the “Enable Highlight” function in user interface 150.

User 108 may also add more data elements per country (or region) using data set entry area 174. Such additional data elements or information can then be displayed in a balloon and used by representation engine 124 for advanced visual styles.

In an embodiment, this exemplary mode may display user interface 150 in a manner that provides user 108 with simplified (or pre-configured) styling options. Such a simplified user interface may be useful for a beginner or an intermediate user who may not need a larger number of user interface options. An example of such a simplified user interface is user interface 152 illustrated in FIG. 1G. Referring to FIG. 1G, by selecting the “Change Polygon Color” option, user 108 can, for example, change the polygon color of the regions of interest (e.g. states) whose visualization is based on a currently selected dataset. User interface 152 also enables user 108 to create balloons (or pop-ups) and even select an algorithm to be used for color interpolation. In this way, user interface 152 can present simplified styling options to user 108 while using such selected options to determine an appropriate shader algorithm and generate stylized representation 170. Exemplary simplified styling options (e.g., change fontsize, polygon height, polygon line color as illustrated in FIGS. 1D-1G.

3.4. Enabling Creation of Multiple Border Outlines with Full Data Styling

In this mode, user 108 can provide a shader algorithm to shader 210 using shader entry area 176. The shader algorithm can configure shader 210 to stylize representation 170 and multiple border outlines using one or more data sets from repository 104. In an embodiment, a shader algorithm generated by shader 210 in the simple data styling mode of section 3.3, can be populated into shader entry area 176 and can be further modified by user 108 to update representation 170. The operation of shader 210 and shader entry area 176 is described above in Section 2.

### 4. Data Table and Data Set Entry Format

In an embodiment, region of interest engine 122 and representation engine 124 may accept a comma separated value (CSV) format as the data input format. In an embodiment, data set entry area 174 accepts input in CSV format and provides the accepted CSV data to region of interest engine 122 and representation engine 124. For example, a CSV input in data set entry area 174 can be:

“Badakhshan”;1;2304;1234;“The story starts here”;

Other exemplary CSV data entry formats, according to the embodiments, appear below:

### Example Format A

“<border name>”; [“<optional: replace outline name with this name>”;][“<optional: replace capital name with this name>”;] <Value1>; [<optional: Value2>;[<optional: Value3>;]]

### Example Format B

“<border name>”; [“<optional: replace outline name with this name>”;] <Value1>; [<optional: Value2>;[<optional: Value3>;]][“<optional: replace capital name with this name>”;]

### Example Format C

“<border name>”; <Value1>; [<optional: Value2>;[<optional: Value3>;]][“<optional: replace outline name with this name>”;] [“<optional: replace capital name with this name>”;]

Using one of the CSV formats listed above, an exemplary table input in data set entry area 174 is illustrated in Example 6.
“Germany”; “Deutschland”; 1; 10;
“France”; “Frankreich”; 2; 9;
“Italy”; “Italien”; 3; 8;
“Greece”; 4; 7; “Griechenland”;
“Austria”; “Oesterreich”; “Wien”; 5; 9;

### EXAMPLE 6

As an example, when the CSV table in Example 6 is provided to data set entry area 174, five countries (i.e., Germany, France, Italy, Greece and Austria) and their respective statistics are retrieved by region of interest engine 122 from repository 104. As shown in Example 5, each retrieved country has two numerical values (e.g., “Germany”; “Deutschland”; 1; 10;) associated with itself which can be used by shader 210 to generate stylized representation 170. Furthermore, in Example 5, displayed label names (e.g. “France”) would be replaced with their respective German translations (e.g., “Frankreich”).

### 5. Example Computer Embodiment

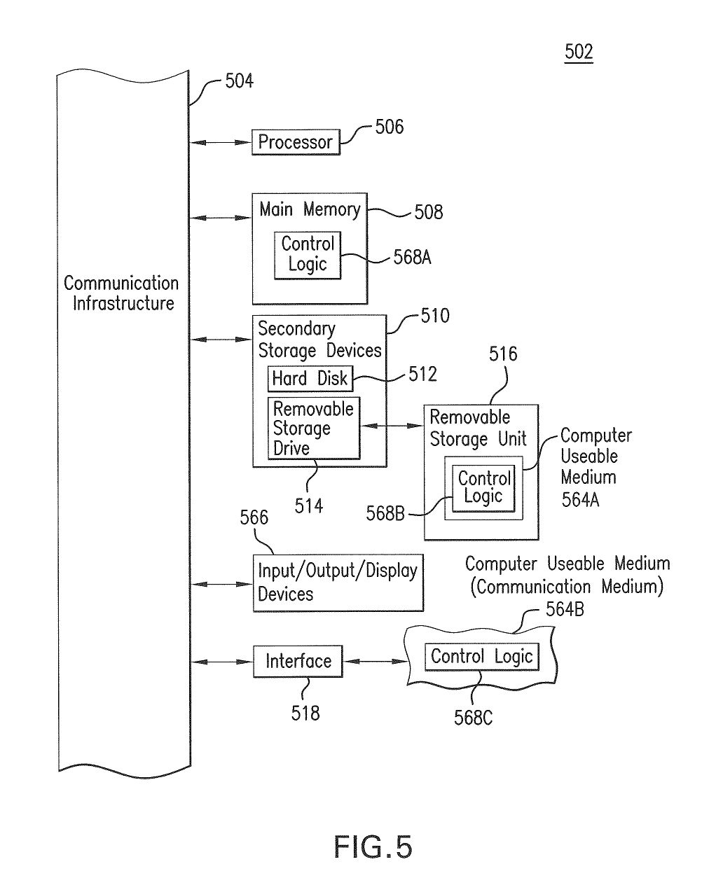

In an embodiment, the system and components of embodiments described herein are implemented using one or more computers, such as example computer 502 shown in FIG. 5. For example, client 120, region of interest engine 122 and representation engine 124 can be implemented using computer(s) 502.

Computer 502 can be any commercially available and well known computer capable of performing the functions described herein, such as computers available from International Business Machines, Apple, Oracle, HP, Dell, Cray, etc.

Computer 502 includes one or more processors (also called central processing units, or CPUs), such as a processor 506. Processor 506 is connected to a communication infrastructure 504.

Computer 502 also includes a main or primary memory 508, such as random access memory (RAM). Primary memory 508 has stored therein control logic 568A (computer software), and data.

Computer 502 also includes one or more secondary storage devices 510. Secondary storage devices 510 include, for example, a hard disk drive 512 and/or a removable storage device or drive 514, as well as other types of storage devices, such as memory cards and memory sticks. Removable storage drive 514 represents a floppy disk drive, a magnetic tape drive, a compact disk drive, an optical storage device, tape backup, etc.

Removable storage drive 514 interacts with a removable storage unit 516. Removable storage unit 516 includes a computer useable or readable storage medium 564A having stored therein computer software 568B (control logic) and/or data. Removable storage unit 516 represents a floppy disk, magnetic tape, compact disk, DVD, optical storage disk, or any other computer data storage device. Removable storage drive 514 reads from and/or writes to removable storage unit 516 in a well known manner.

Computer 502 also includes input/output/display devices 566, such as monitors, keyboards, pointing devices, Bluetooth devices, etc.

Computer 502 further includes a communication or network interface 518.

Network interface 518 enables computer 502 to communicate with remote devices. For example, network interface 518 allows computer 502 to communicate over communication networks or mediums 564B (representing a form of a computer useable or readable medium), such as LANs, WANs, the Internet, etc. Network interface 518 may interface with remote sites or networks via wired or wireless connections.

Control logic 568C may be transmitted to and from computer 502 via communication medium 564B.

Any tangible apparatus or article of manufacture comprising a computer useable or readable medium having control logic (software) stored therein is referred to herein as a computer program product or program storage device. This includes, but is not limited to, computer 502, main memory 508, secondary storage devices 510 and removable storage unit 516. Such computer program products, having control logic stored therein that, when executed by one or more data processing devices, cause such data processing devices to operate as described herein, represent the embodiments.

Embodiments can work with software, hardware, and/or operating system implementations other than those described herein. Any software, hardware, and operating system implementations suitable for performing the functions described herein can be used. Embodiments are applicable to both a client and to a server or a combination of both.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer implemented method for stylized map generation, comprising:
(a) enabling a user to provide a geographical region of interest;
(b) retrieving a multi-dimensional data set associated with the region of interest;
(c) determining an area outline of the region of interest based on an intersection of the data set with the region of interest; and
(d) generating a graphical representation of the region of interest and the area outline based on the data set,
wherein steps (a)-(d) are performed using one or more processors.

2. The method of claim 1, wherein step (d) comprises:
instantiating a shader to generate the area outline; and
processing a shader algorithm to configure the shader.

3. The method of claim 2, further comprising:
generating the area outline using representative values from each dimension of the multi-dimensional data set.

4. The method of claim 2, further comprising:
applying a style package to the generated representation; and
modifying the style package using the shader algorithm.

5. The method of claim 4, wherein the modifying comprises:
modifying the style package, in real time, based on user input.

6. The method of claim 2, further comprising:
analyzing the shader algorithm for malicious code.

7. The method of claim 4, further comprising:
interpreting the shader algorithm, in real time, as the shader algorithm is input by the user; and
updating the style package based on the interpreting.

8. A computer-based system for stylized map generation, comprising:
one or more processors;
a repository configured to store a plurality of multi-dimensional data sets;
a region of interest engine configured to determine an area outline of a geographical region of interest based on an intersection of a data set with the region of interest; and
a representation engine configured to generate a graphical representation of the region of interest and the area outline based on the data set,
wherein the region of interest engine and the representation engine are implemented using the one or more processors.

9. The system of claim 8, wherein the representation engine further comprises a shader configured to generate the area outline using representative values from each dimension of the multi-dimensional data set.

10. The system of claim 8, wherein the graphical representation comprises a shaded region and place-mark map.

11. An article of manufacture including a computer-readable medium having instructions stored thereon that, when executed by a computing device, cause the computing device to perform operations comprising:
enabling a user to provide a geographical region of interest;
retrieving a multi-dimensional data set associated with the region of interest;
determining an area outline of the region of interest based on an intersection of the data set with the region of interest; and
generating a graphical representation of the region of interest and the area outline based on the data set.

12. The article of manufacture of claim 11, the generating comprising:
instantiating a shader to generate the area outline; and
processing a shader algorithm to configure the shader.

13. The article of manufacture of claim 11, the operations further comprising:
generating the area outline using representative values from each dimension of the multi-dimensional data set.

14. The article of manufacture of claim 12, the operations further comprising:
applying a style package to the generated representation; and
modifying the style package using the shader algorithm.

15. The article of manufacture of claim 14, the modifying further comprising:
modifying the style package, in real time, based on user input.

16. The article of manufacture of claim 14, the operations further comprising:
analyzing the shader algorithm for malicious code.
